(19) United States
(12) Patent Application Publication
(10) Pub. No.: US 2002/0129103 A1
(43) Pub. Date: Sep. 12, 2002

(54) Instant messaging presence service protocol

(76) Inventors: J?ouml;rgen Birkler, Malmo (SE); Lars Novak, Lund (SE); Marcel Wong, Lund (SE)

Correspondence Address: JENKENS & GILCHRIST, P.C., Suite 3200, 1445 Ross Avenue, Dallas, TX, 75202-2799, US

(21) Appl. No.: 09/973,333

(22) Filed: Oct. 9, 2001

Related U.S. Application Data
(60) Provisional application No. 60/275,203, filed on Mar. 12, 2001.
(60) Provisional application No. 60/275,205, filed on Mar. 12, 2001.

(51) Int. Cl. G06F 15/16

(52) U.S. Cl. 709/203

(57) ABSTRACT

A method for updating presence information between a client and a server wherein an update request having a first presence information version number associated therewith is transmitted from the client to a server. The first presence information version number is compared with a second presence information version number at the server. If the first and second version numbers do not match, a presence information update response is transmitted from the server to the client. If the first and second version numbers do match, a presence information update response is delayed until receipt of a new update or expiration of a timeout period.

### RELATED APPLICATION(S)

This application claims priority from and incorporates herein by reference the entire disclosure of U.S. Provisional Application Serial No. 60/275,203 filed Mar. 12, 2001 and U.S. Provisional Application Serial No. 60/275,205 filed Mar. 12, 2001.

### TECHNICAL FIELD

The present invention relates to instant messaging systems, and more particularly, to an instant messaging presence service for providing updated presence information on individuals.

### BACKGROUND OF THE INVENTION

An instant messaging service provides a number of different services to users of computing and mobile computing devices. Presence services provide a system wherein users register presence information such as state (online/offline, busy, coffee break, etc), moods (happy, sad, bored), location (home, work) and other information. Users may add friends and colleagues to their contact list and subscribe to presence information for each of these individuals. Session set-up services enable a user to establish a session with other users. The session can be a public or private chat session. Public chat sessions are available to all users of an instant messaging service, while private sessions are only visible to users involved in a particular session. The messages within a chat session are based upon the evolution of the MMS (multi media messaging service) and SMS (short message service) protocols. Search services enable a user to search for other users to establish a session with or to add to their contact list. The search can be based on differing criteria such as age, gender or hobbies. Instant Message Delivery Services enable a user to send messages to other users. These messages are delivered instantaneously. The type of message depends upon the type of terminal utilized. Newer terminals that support this instant messaging services will use messages based on the MMS messaging protocol while older instant messaging terminals may use the SMS messaging protocol.

As mentioned above, instant messaging and presence services (IMPS) enable a user to view presence information about other users on their contact list. One way in which this information may be updated is to implement a request/response protocol. In a request/response protocol, at regular intervals, a client issues a request for the latest presence information on their subscribed user list to a server. The server responds with presence information on these subscribed users. This system provides several advantages such as scalability (the server does not need to keep track of specific clients); no subscription/registration is needed (the same user may have multiple clients); denial of service is easier to handle; the system maps directly to HTTP and WAP/WSP protocols; and the response/updates are easily routed to the client. However, the problem with this type of system is that the client's presence information may not be up to date. Because the client only polls the server at regular intervals for information, the presence information may not be updated at a client until the next polling period. Thus, some means for more quickly updating presence information between a client and server utilizing instant messaging and presence services would be desirable.

### SUMMARY OF THE INVENTION

The present invention overcomes the foregoing and other problems with a method for updating presence information between the client and a server wherein a presence information request, including a first version number associated with presence information presently stored at a client is transmitted from the client to a server. The version number transmitted from the client is compared with a version number associated with presence information at the server to determine if the version numbers match. If the version number from the client does not match the version number of the presence information at the server, updated presence information presently stored within the server is forwarded to the client along with the new version number. If the version number transmitted from the client matches the version number of the presence information at the server, the forwarding of presence information from the server to the client is delayed until the receipt of updated presence information at the server. At that time, the updated presence information and the new version number of the updated presence information are forwarded back to the client. In a further embodiment, delay of forwarding of presence information from the server to the client may be limited to a selected period of time before transmission to the client of an update indicating no change in the presence information.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a functional diagram of the implementation of an instant messaging system within a 2G wireless network;

FIG. 2 is a functional diagram of an instant messaging system implemented within a 2.5 G/3 G wireless network;

FIG. 3 illustrates a prior art representation of a response/request protocol for updating presence information between a client and server;

FIG. 4 illustrates a first implementation of a new response/request protocol between a client and server according to the method of the present invention;

FIG. 5 illustrates an update request message including a version number of presence information within the client;

FIG. 6 illustrates an update response message including a new version number of presence information at the server;

FIG. 7 illustrates a response/request protocol between a client and server when updated presence information exists within the server;

FIG. 8 illustrates the request/response protocol using a time out response,

FIG. 9 illustrates a response message according to the protocol of FIG. 8, and

FIG. 10 is a flow diagram illustrating the operation of the request/response protocol of the present invention.

### DETAILED DESCRIPTION

Referring now to the drawings, and more particularly to FIG. 1, there is illustrated an instant messaging system implemented within a 2 G wireless network 10. A messaging terminal 15 communicates through the 2 G wireless network 10 to a short message service (SMS) server 20, a home location register (OLR) 25 and a wireless application protocol (WAP) gateway 30. The HLR 25 stores user profile information for the messaging terminal 15. An instant messaging server 40 connects to the messaging terminal 15 via the WAP protocol through the WAP gateway 30 and a WAP relay 45. Alternatively, the messaging terminal 15 may contact the instant messaging server 40 using the SMS protocol to the SMS server 20 and SMS relay 50. The instant messaging server 40 is connected to other instant messaging servers 55 via the Internet 60 using an instant messaging server to server protocol.

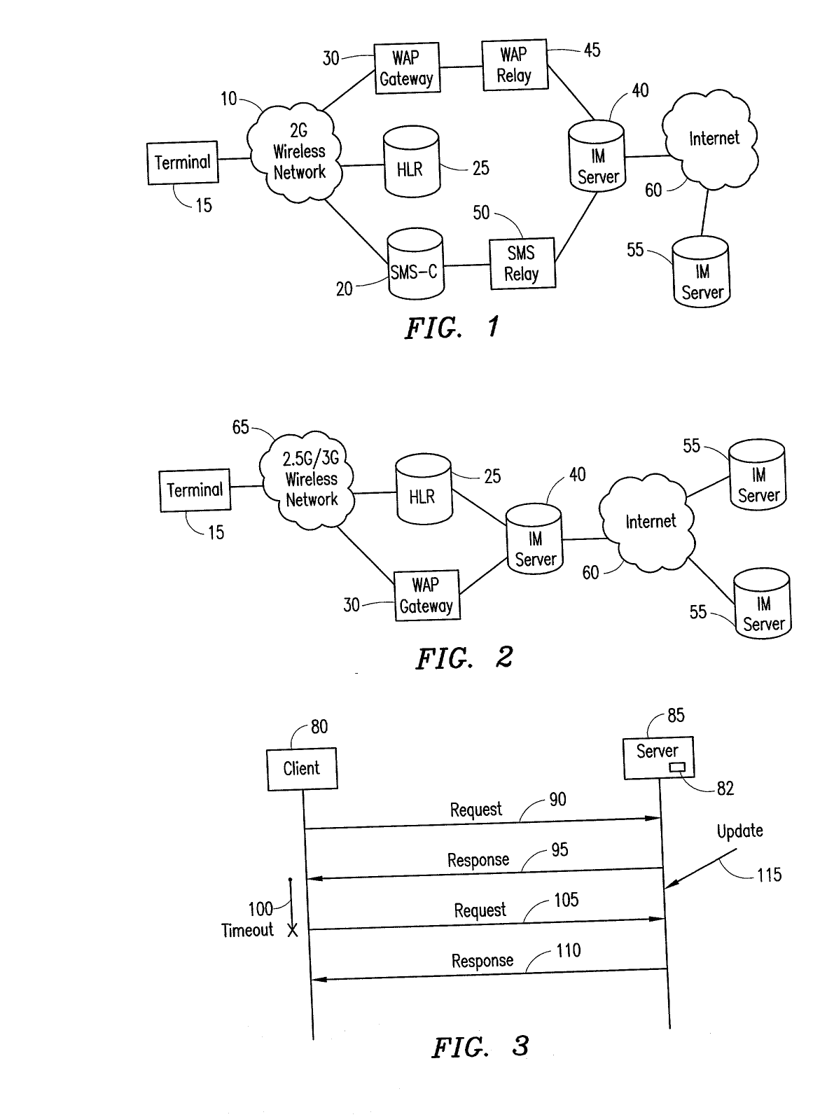

Referring now to FIG. 2, there is illustrated an implementation of an instant messaging service system within a 2.5 G (GPRS)/3 G wireless network 65. In this system, an instant messaging mobile client 15 communicates through the wireless network 65 using a WAP gateway 30 directly to the instant messaging (IM) server 40. This IM server 40 may likewise communicate with other IM servers 55 over the Internet 60 using a server to server protocol. The IM server 40 is also connected to the HLR 25 to enable the use of presence information. These are only examples of frameworks within which the instant messaging services system can be implemented. Other frameworks and implementations using variations of instant messaging are also possible.

Referring now also to FIG. 3, there is illustrated a prior art method wherein a request/response protocol is implemented between a client 80 and a server 85. In the prior art protocol, a request 90 is transmitted from the client to the server and an update response 95 is transmitted back to the client 80 from the server 85 in response thereto. A selected time out period 100 is exercised at the client until a next request 105 is transmitted to the server 85 for a further update response 110. The problem with this system is that if an update 115 occurs after a response 95 and during the timeout period 100, the client 80 will have to wait for expiration of the timeout period 100 to receive an update of the presence information at the server.

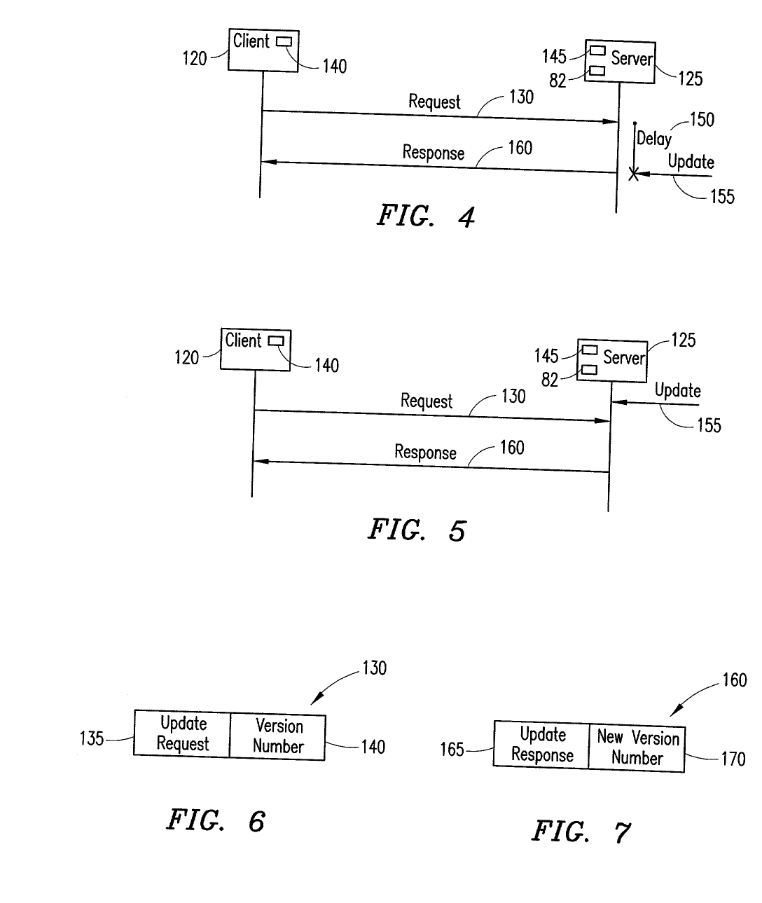

Referring now to FIG. 4, there is illustrated the request/response protocol of the present invention. An update request message 130 is transmitted from client 120 to the server 125. The update request message 130 provides a request for updated presence information for individuals stored in the client's contact list 82 stored at the server 125. As illustrated in FIG. 6, the request message 130 includes the request portion 135 and a presence information version number 140. The version number 140 is associated with the presence information presently stored at the client 120. The version number 140 contained within the request message 130 is compared with a presence information version number 145 stored at the server 125. If the version number within the request message 130 matches the version number 145 of presence information stored within the server 125, a delay 150 of a response to the client is initiated at server 125 until a presence information update 155 is received at server 125. In response to the update 155 received at the server 145 during the delay 150, a presence information update response message 160 (FIG. 7) is transmitted from the server 125 to the client 120. The response message 160 includes the updated presence information 165 received at the server 125 along with a new version number 170 for the presence information which may be stored as the version number 140 at the client 120.

Referring now to FIG. 5, there is illustrated a further implementation of the protocol wherein a request 130 to the server 125 includes a version number 140 different from the presence information version number 145 associated with the presence information at server 125. When these numbers are different, this indicates that an update 155 has occurred at the server 125 since the last response 150 from the server 125, and an update response 160 (FIG. 7) is immediately transmitted from the server 125 to the client 120 including the updated presence information 165 and the new version number 170.

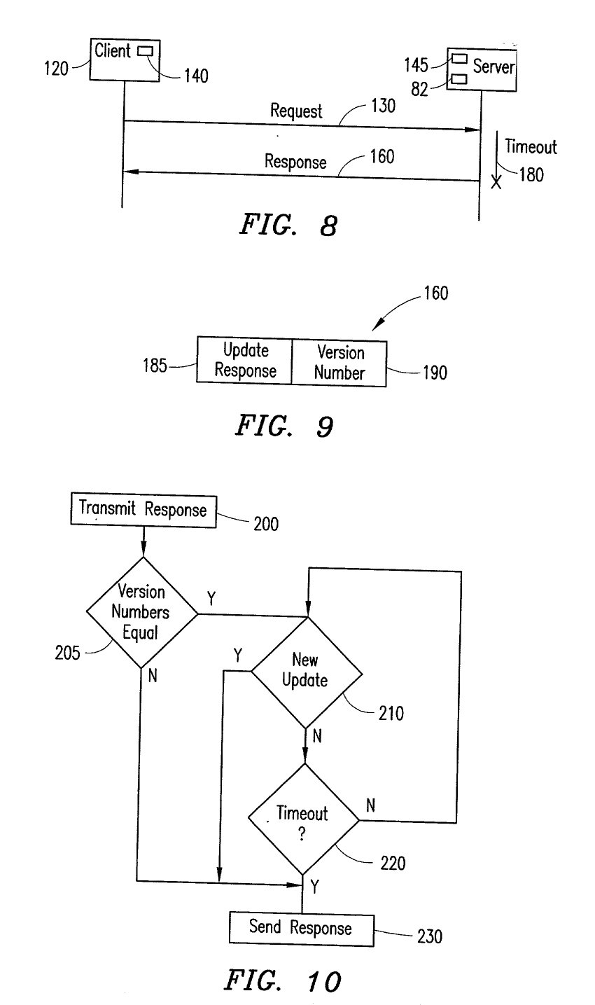

Referring now to FIG. 8, there is illustrated an alternative embodiment of the protocol wherein when the version number 140 transmitted within the update request 130 does match the version number 145 of the presence information within the server 125 and no update 155 is received at the server 125 for a selected period of time. A response 160 may be transmitted from the server 125 to the client 120 after expiration of a selected timeout period 180. The response 160 (FIG. 9) would include a response indication 185 showing that no presence information needs to be updated and the same version number 190 that was originally transmitted with the request 130 from the client 120.

Referring now to FIG. 10, there is illustrated a flow diagram summarizing the update response/request protocol of the present invention. An update response is transmitted from the client 120 at step 200 to the server 125. Upon receipt of the update response at the server 125, a comparison is made at step 205 between the presence information version number within the update request and the version number of the presence information at the server 85. If these version numbers are equal to each other, control passes to inquiry step 210 to determine if an update has been received since receipt of the update request. If not, inquiry step 220 determines whether the timeout period has expired. If not, control returns back to inquiry step 210. Once a new update is detected at inquiry step 210 or expiration of the timeout period is detected at inquiry step 220, an update response is sent back to the client 80 from the server 85 including a version number. If inquiry step 205 determines that the version number of the presence information in the request does not equal the version number of the presence information at server 85, a response is immediately sent back to the client at step 230 including the new version number and updated presence information.

The previous description is of a preferred embodiment for implementing the invention, and the scope of the invention should not necessarily be limited by this description. The scope of the present invention is instead defined by the following claims.

What is claimed is:

1. A method for updating presence information between a client and a server, comprising the steps of
transmitting an update request for presence information including a first version number associated with presence information at the client from the client to the server;
comparing the first version number from the client with a second version number at the server, the second version number associated with presence data at the server;
if the first and second version numbers to not match, forwarding a presence information update response from the server to the client; and
if the first and second version numbers match, delaying forwarding of a presence information update response from the server to the client.

2. The method of claim 1, wherein the step of delaying further comprises the step of delaying forwarding of the presence information update response until receipt of an update at the server.

3. The method of claim 2, further including the step of forwarding the delayed presence information update response from the server to the client.

4. The method of claim 3, wherein the delayed presence information update response has a third version number associated therewith.

5. The method of claim 1, wherein the forwarded presence information update response has the second version number associated therewith.

6. The method of claim 1, wherein the first version number is originally provided from the server.

7. A method for updating presence information between a client and a server, comprising the steps of
transmitting a presence information request including a first version number associated with the presence information at the client from the client to the server;
comparing the first version number with a second version number associated with the presence information at the server to determine if the first and the second version numbers match.
if the first and the second version numbers do not match, forwarding updated presence information and the second version number to the client from the server; and
if the first and the second version numbers match, delaying forwarding updated presence information to the client from the server unit at least one of receipt of updated presence information at the server or expiration of a selected time period.

8. The method of claim 7, wherein the delayed updated presence information response has a third version number associated therewith.

9. The method of claim 7, wherein the first version number is originally provided from the server.

10. A method for updating presence information of a client, comprising the steps of:
receiving a presence information update request having a first presence information version number associated therewith at the server;
comparing the first presence information version number with a second presence information version number associated with presence information at the server to determine if the first and second presence information version numbers match;
if the first and second presence information version numbers do not match, forwarding updated presence information and the second version number to the client; and
if the first and second presence information version numbers match, delaying forwarding the update presence information and a third presence information version number to the client until receipt of the updated presence information at the server.

11. The method of claim 10, wherein the step of delaying further comprises delaying forwarding the updated presence information having the third presence information version number associated therewith until at least one of the receipt of the updated presence information at the server or expiration of a selected time period.

12. A server, comprising:
an interface for connecting the server to receive a presence information update request having a first version number associated therewith from a client and transmit a presence information update response to the client; and
wherein said server is configured to compare the first version number to a second version number associated with presence information at the server, transmit updated presence information to the client if the first and second version numbers do not match, and delaying forwarding of the updated presence information to the client until receipt of updated presence information if the first and second version numbers match.

13. The server of claim 12, wherein the server is further configured to forward the delayed update response from the server to the client upon receipt of the updated presence information.

14. The server of claim 13, wherein the delayed presence information update response has a third version number associated therewith.

15. The server of claim 12, wherein the forwarded presence information update response has the second version number associated therewith.

16. The server of claim 12, wherein the server is further configured to delay forwarding for only a selected period of time.

17. A client, comprising:
an interface for connecting the client to transmit a presence information update having a first version number associated therewith to a server and receive a presence information update response from the server; and
wherein said client is configured to include a presently stored first version number with each presence information update request and to update the presently stored first version number responsive to a receive presence information update response.
